(19) United States
(12) Patent Application Publication
(10) Pub. No.: US 2018/0114244 A1
(43) Pub. Date: Apr. 26, 2018

(54) ANTI-HOPPER AND LOYALTY PROGRAM

(71) Applicant: Timothy McGee, Holyoke, MA (US)

(72) Inventor: Timothy McGee, Holyoke, MA (US)

(21) Appl. No.: 15/791,874

(22) Filed: Oct. 24, 2017

Related U.S. Application Data
(60) Provisional application No. 62/412,265, filed on Oct. 24, 2016.

(51) Int. Cl. G06Q 30/02

(52) U.S. Cl. CPC G06Q 30/0226; G06Q 30/0277; G06Q 30/0269; G06Q 30/0246; G06Q 30/0275

(57) ABSTRACT

This invention relates to manufacturing and distribution of physical digital media, such as DVD, Blu-ray, or CD formats. The present invention relates particularly to adding a methodology for preventing skipping of selected advertising media imbedded within such digital Medias as well as adding a product or brand loyalty as well as a web-based advertising tracking system to such digital media in conjunction with the digital media.

### CROSS-REFERENCE TO RELATED APPLICATION

This application is claims priority to U.S. Provisional Application No. 62/412,265 filed Oct. 24, 2016. This application is incorporated herein in its entirety.

### FIELD OF THE INVENTION

The present invention relates generally to the field of entertainment as well as marketing vendor products and tracking consumer demand therein, and more specifically to marketing compact discs containing entertainment with anti-skip media technology, and web-based tracking and loyalty systems thereon.

### BACKGROUND

Compact discs have been available for over three decades. During that time, consumers have been provided with a multitude of visual and audio media: music, television shows, movies, video games, educational games, photo galleries and a vast array of software options.

Despite a trend toward wireless media in recent years, compact discs (be they in the format of CD-Rs, CD-RWs, DVDs, DVD-Rs, DVD-RWs, or some other similar format), still fulfill the media needs of millions of consumers. Just as media books are quite popular to current consumers, there is still a love of tradition for many to hold a tangible book in their hand to read. Ironically, the same may be said of compact discs.

Some consumers will maintain their collection of compact discs as they represent something more tangible than a wireless piece of media catalogued and held in a virtual stratosphere, subject to being turned off at any time. Considering the trend, championed by such companies as Sony, to characterize transactions in which a consumer pays for their movies or music as being “leased” as opposed to “purchased,” the notion of actively possessing something on a purchased and owned compact disc or DVD will continue to appeal to a certain number of consumers.

Adverting is literally all around us. Advertisers seek to put their promotions anywhere upon which potential consumers are likely to fix their gaze. Advertisers continue to attempt to reach target audiences through various means. They still placing advertising on television, in radio, on billboards and before film features shown in theaters, and imbedded within movies or television shows.

As movies and television have begun to be shown also on the internet as well continuing to appear in a multitude of pay channels, the number of areas in which to advertise has become decentralized and, thus, more expensive for advertisers to advertise; there is literally more “property” to cover in order to appeal to the same number of consumers, or a particular demographic group, as say thirty (30) years ago. Among this expanded property are video games, which have become quite popular on wired as well as wireless media. These advertisers must find ways to compete within the flood of advertising online, so called pop-ups, to be able to successfully advertise their products. They must also find ways to seed eye-catching advertising within the rapid scrolling of so-called “social media” in which busy (and arguably attention-deficient consumers interact with their virtual friends and exchange information at a rapid pace.

All of these challenges make it more difficult for advertisers to reach a target demographic, say a group of people aged 12-25 or another group aged 48-65, with an appropriate and ultimately successful advertising and marketing methodology.

Much of the current media allow consumers to scroll past, to “close” or to “skip” advertising. Gone are the days when consumers would perforce sit through commercials on television or in a movie theater. Now, while television networks have their online presence and include mandatory-viewing commercials at pre-set points during a television show, consumers have many entertainment options beyond the traditional networks in which they are provided with more control over when and how they view product advertising. In addition, certain web applications provide their customers with the option of opting out of advertising altogether for a relatively small monthly fee, thus further limiting advertiser access to consumers.

Over the years, certain advertisers have distributed compact discs or DVDs in different settings, to varying degrees of success, as these distribution products and schemes have had certain drawbacks. In the past, some companies have given away, for example, compact discs that allow a user to sign up for an internet service provider's (i.e., ISP's) service and set up an account; video game companies have given away discs with certain demonstration game modules in order to encourage the consumer to buy the game or they will sell the module for a lower price than the full game; and music publishers have given away special compilations of an artist's, or group of artists′, music for purposes of enticing the consumer to outright purchase their musical offerings in the future. While some advertising can be made to accompany or be imbedded within these promotional products, the consumer's use of the media is likely to be short-lived and of limited benefit to the company beyond the hope that the consumer will buy more through the internet connection, buy the video game, or an artist's CD or DVD.

Consumers wish to receive something that is of value to them personally, and they may also have interests that may or may not mesh with a particular advertiser or its advertisement. For example, a person who enjoys popular music may not have an interest in viewing or receiving advertising from an internet service prover or a car manufacturer, but if such a product were advertised in the right way to such a consumer, a car manufacturer may acquire a new client. Advertising to those individuals who lack a current interest in a certain product or service may engender such an interest in the future, and that can bring value to both an advertiser and a consumer.

It is therefore of benefit for an advertiser to proffer a method of advertising which is broader than those currently available, meaning a method that does not limit companies to advertise to limited or overly narrow demographic groups.

### SUMMARY

The invention relates to providing a method that prevents time shifting or skipping of advertisement and apparatus marketing uses for compact disc (DVD and Blue Rays) in conjunction with a company's web portal or apps for an overall media experiences. The examples include (programming) content with advertisement on compact disc and intergrading it with the inability to time shift or skip the advertisement. The design illustrates that the finished compact disc can be given a way, in most cases for free. In some cases, the viewer may be charged a fee or have to purchase a product or services to obtain the disc for free. In one aspect, the advertisers pay a fee to be included on the compact disc. The design for the app and web portal illustrate the functionality that allows the viewers to extent the media experiences to games, trivia, puzzles in exchange for (points, tokens) that can only be used at the company's web site (portal), penny auction site to buy advertiser's offerings at huge discounts, etc.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIGS. 1A and 1B illustrate the general methodology of compiling a DVD of the present invention;

FIGS. 2A, 2B and 2C illustrate general methodology of the marketing concept behind the loyalty program and tracking system of the present invention;

FIGS. 3A, 3B, and 3C illustrates general methodology of the Anti-Hopper system of the present invention; and

FIG. 4 illustrates general methodology of the marketing concept associated with the present invention.

### DETAILED DESCRIPTION

The present invention includes compact discs in the following manner due to data capacities Standard DVD with 4.7 GB (single-sided, single-layer—common) can hold two television shows with commercials or music videos with commercials. An 8.5 GB (single-sided, double-layer) can hold a movie with commercials as well 9.4 GB (double-sided, single-layer) can hold a movie with commercials. In comparison, a Blu-ray Disc, the successor to the DVD format, uses a wavelength of 405 nm (violet), and one dual-layer disc has a 50 GB storage capacity. Herein the term compact disc refers to the list above to a physical disc in any number of different formats to utilize the data capacities of each for the purposes of the invention.

The present invention includes a compact disc having content (music video, movies, television series) with advertisement in any number of formats and embedded print media on the case with DVD being distributed to the viewers, in some cases for free. The advertisements sold can be niched drive like cable or broad like the networks with no correlation to the movies being exhibited on the compacted disc. Embedded on each of the discs can be a graphical interface for the invention loyal program section during the telecast of content and/or advertisement.

The media of the content (music video, movies, and television series) and advertisement media can be assembled with the DVD authoring software in a manner that correlates to the present invention of the Anti-Hopper described herein, to the specific physical disc data capacities listed as above. A menu can be structured to current market conditions and providing functionality that allows viewers to selected from a list of traditional option, in popular DVD menus from play movie, to chapter points, Bonus section, languages and close captioning section, etc. In addition, the remote functionality can provide standard media content features (Fast-forward, Rewind, Play, Stop, Skip, etc.) like standard DVR players. With the notable exception that during the commercial section of the compact disc the functionality of the remote control can be disable preventing the viewers from skipping any commercial section of the telecast. We label this the Anti-Hopper. In some case we can have a head and tail between the commercial where functionality of the remote control can be disabled as well.

The advertisement can be in a number of forms from standard videos, audio, and graphics both in still and motion forms. They can be arranged with the content in the same industry structure of 7, 11, or 22 minute segments every half hour. There may also be time during the content delivery when a motion graphic or logo or icon that appears in the corners of the frames to scrolling bars. There are a number of arrangements to include, but not just limited to, voice overs that stated “this program is brought to you by” with shot of stills to just voice over with introduction. As part of the advertisement loyalty program a motion graphic or icon that appears in the corners of the frames and/or a scrolling bar with voice over during the telecast of commercials and content of media programming can be embedded.

The advertisement loyalty program tracks how many people who get the movie watch it and how many are engaged. How it functions is messages with a code for viewers to enter into a mobile device application or at the company's web portal to play along with the overall experiences. The code can allow the viewer to active the question and answer trivia section to other games and puzzles to play in a short time period during the video telecast. With every right answer the viewer can obtain a “marker” (token, point and/or penny) to be used at the company auction site and the end of the week. The engagement takes place when viewers buy from the auction site the products and services being advertised during the telecast.

Once the media is edited and arranged in a list of videos tracks they can be linked to the menu structures. After being tested and checked, the data can be mastered out to the DVD. Here the DVD can be tested and checked again before it is used as the master to duplicate additional DVDs to be shipped out to public. These DVDs can play on any compatible device.

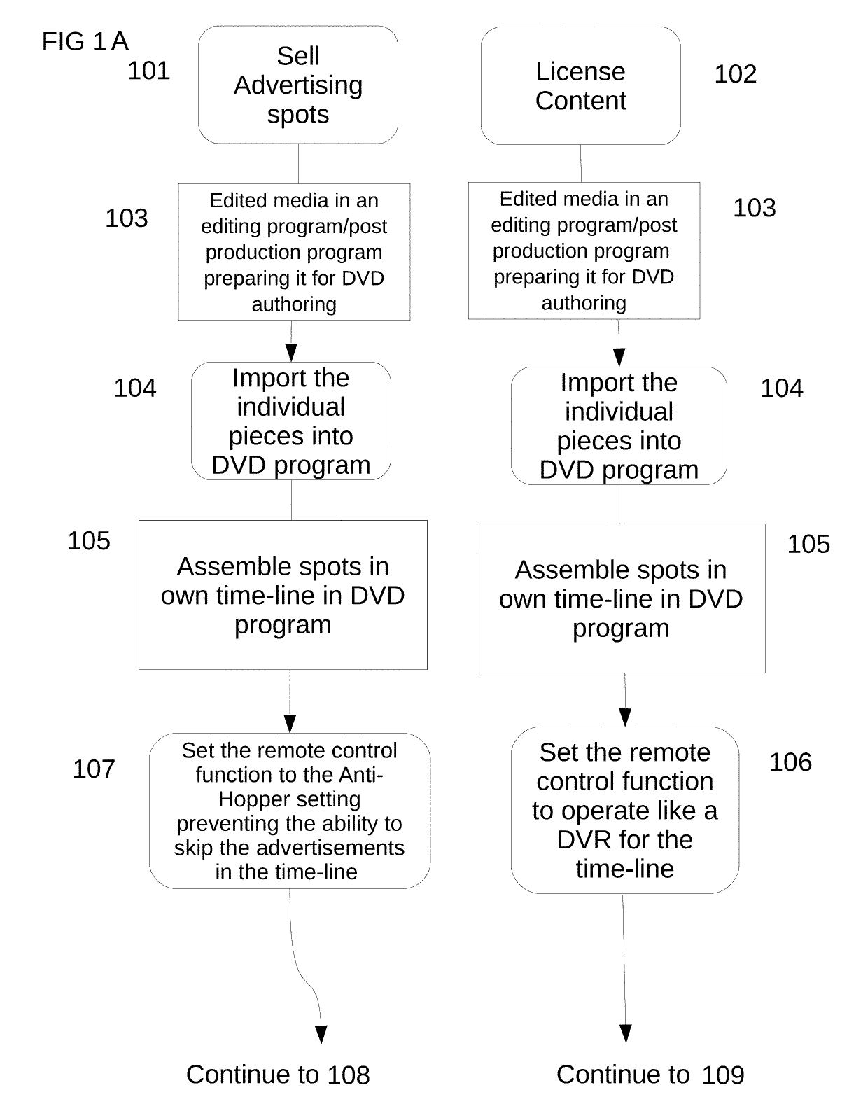

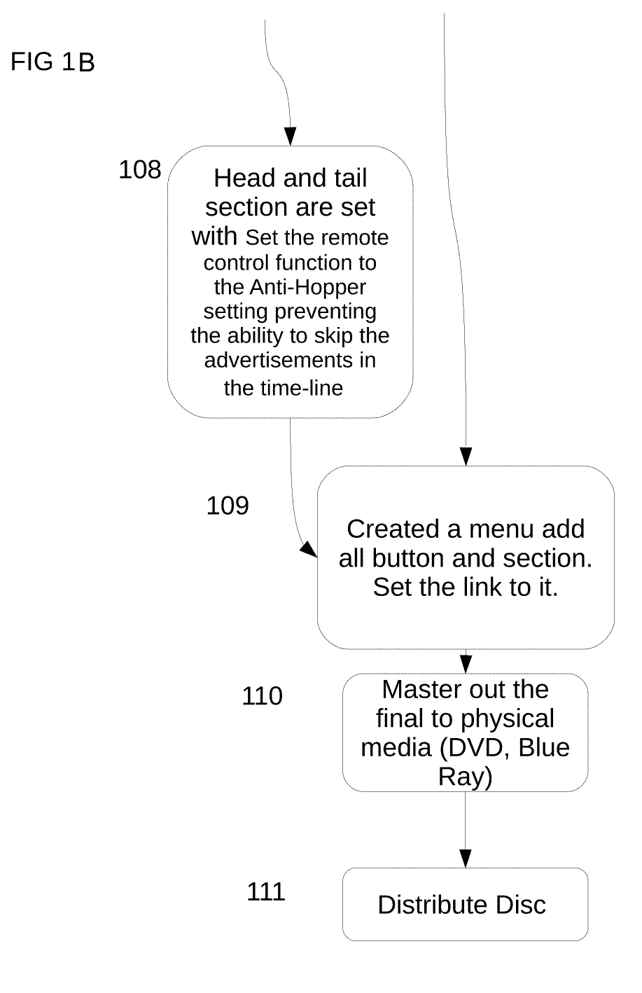

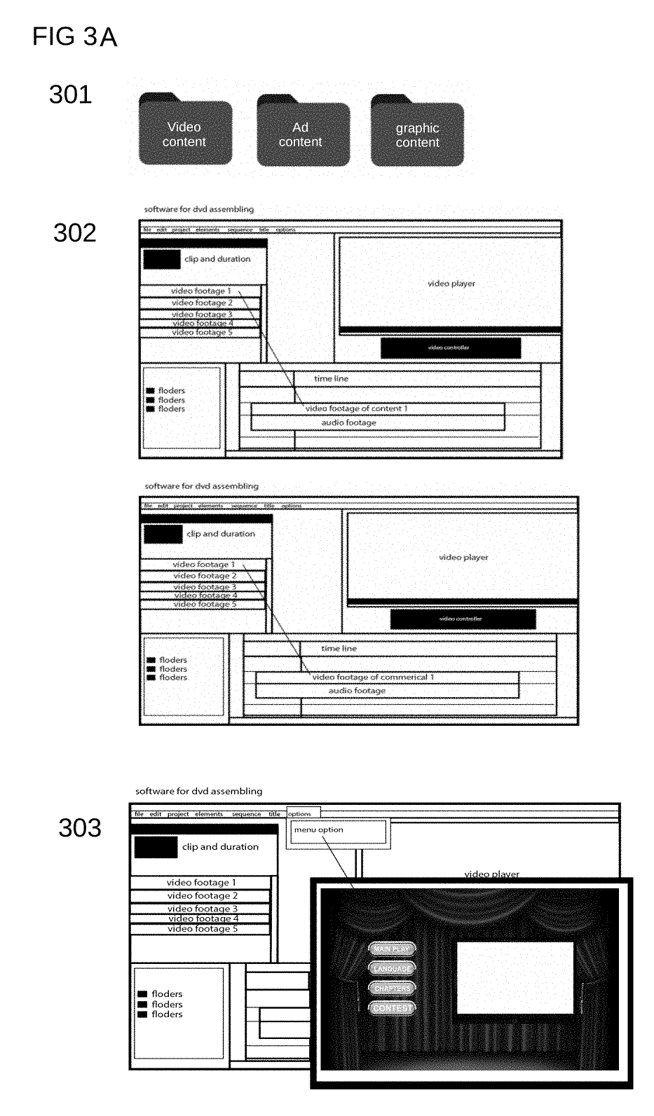

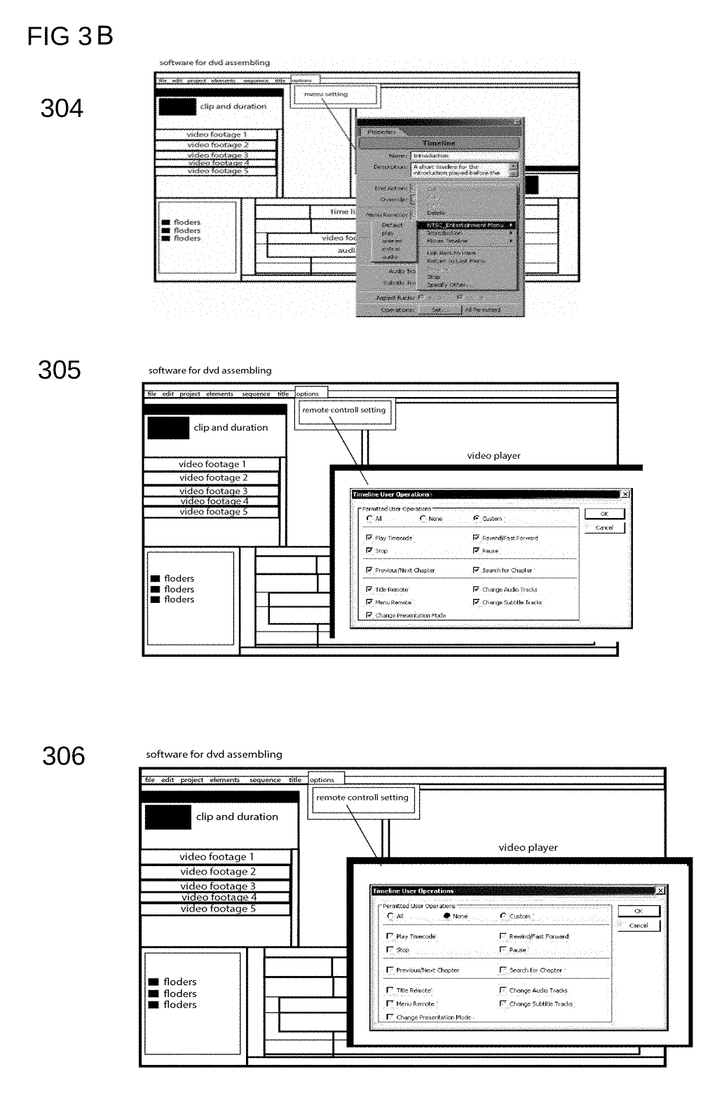

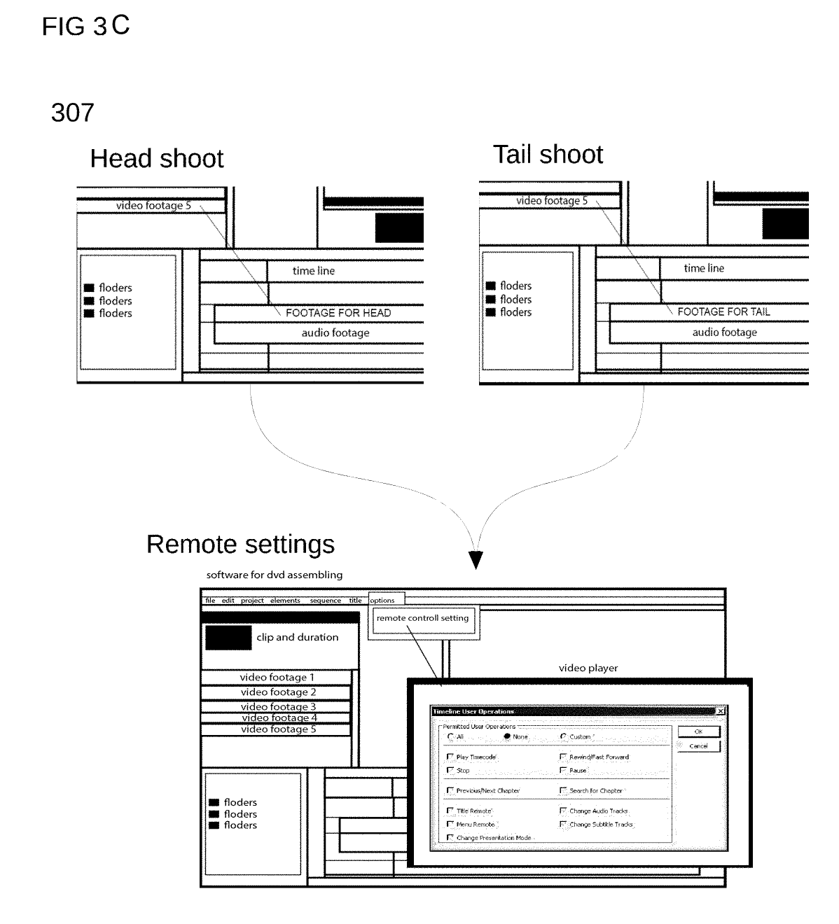

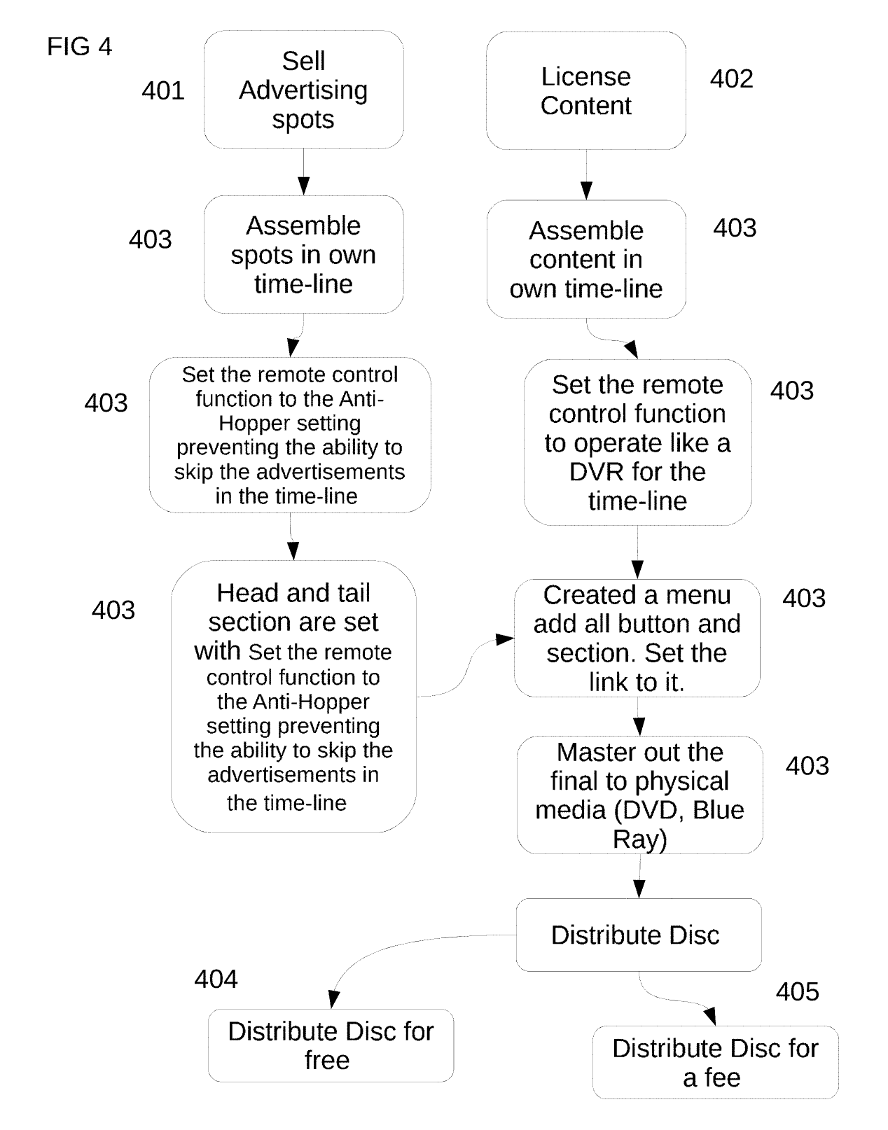

FIGS. 1A and 1B illustrate the general methodology of the compiling of the DVD. FIG. 1B is the next section of FIG. 1A. The company can seek to sell its advertisement space (step 101) for the DVD to traditional advertisement agency but not limited to selling to just agencies. Other sales options are directed sales, online and barter and trade. The company can seek to obtain licensed-in content from providers (step 102) and edit the material together (see, FIGS. 3 and 4) with its loyalty program and the Anti-Hopper technology format. The media is edited in an editing program (step 103) (e.g. Premiere) and sent to another video graphic program (e.g. After Effects) to insert a motion graphic or icon that appears in the corners of the frames and or a scrolling bar with voice over during the telecast of commercials and content of media programming (step 104). The individual pieces of material can be assembled in the DVD authoring program according to industry standards (step 105). With each piece of media in its own timeline, the content can be arranged with advertisements breaks in the same industry structure of a 7, 11, or 22 minute segment per half hour (step 105). The remote functionality can be set to provide normal (Fast-forward, Rewind, Play, Stop, Skip) functions like DVR players during the content section (step 106). The remote functionality during the commercial section of the compacted disc can be disabled preventing the viewers from skipping or time shifting any commercial section of the telecast (step 107). This function is referred to throughout as the “Anti-Hopper”. In some case we can have a head and tail between the commercial where functionality of the remote control can be disabled as well (step 108). Menus can be structured in the manner to current market condition providing functional that allows viewers to selected from a list of traditional option, in popular DVD menus from play movie, to chapter points, Bonus section, languages and close captioning section, Contest (step 109). The DVD can then be compiled with the data and media onto the DVD disc ready to be distributed to the end users (step 110) and then distributed to end user (step 111).

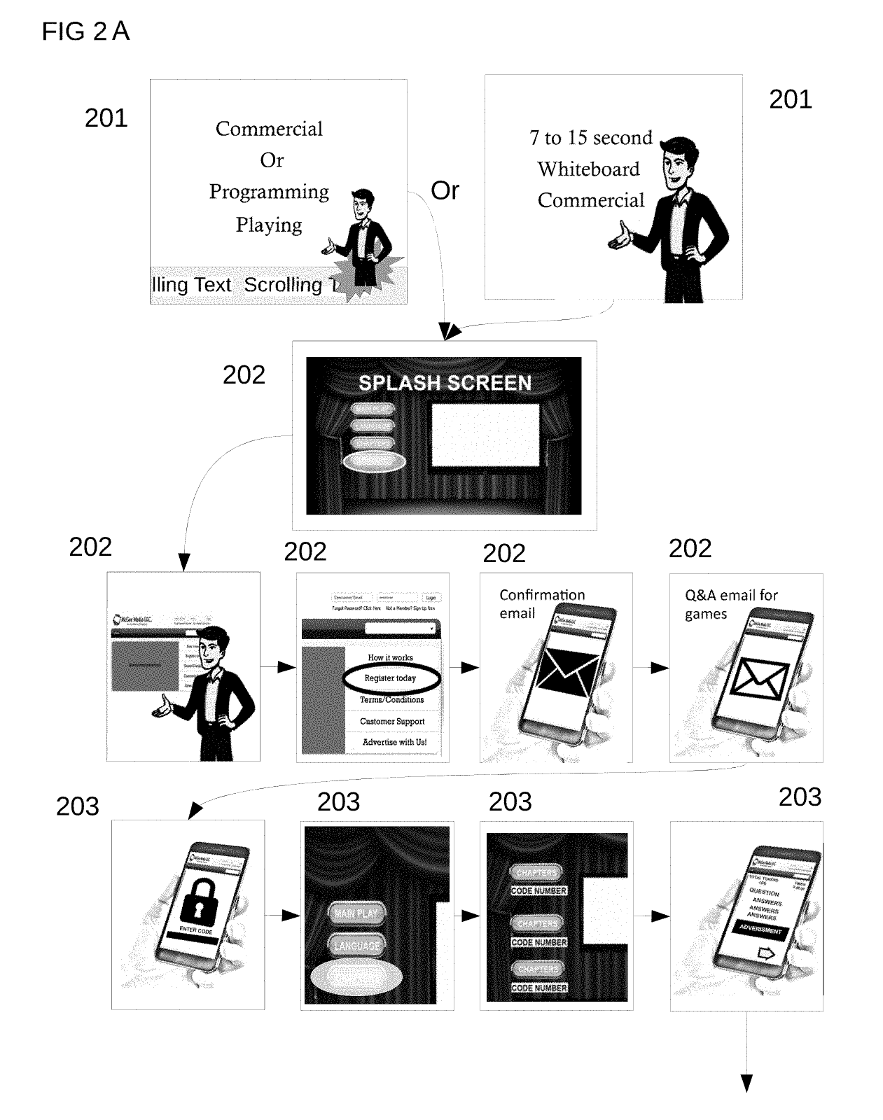

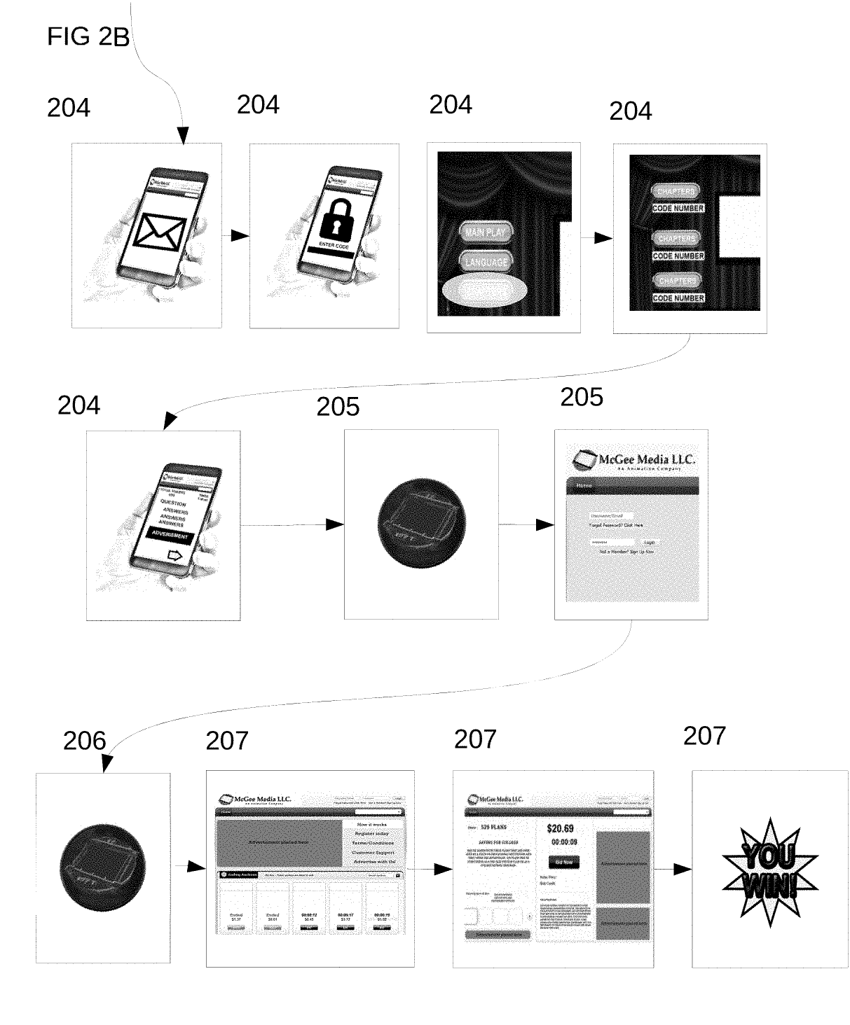

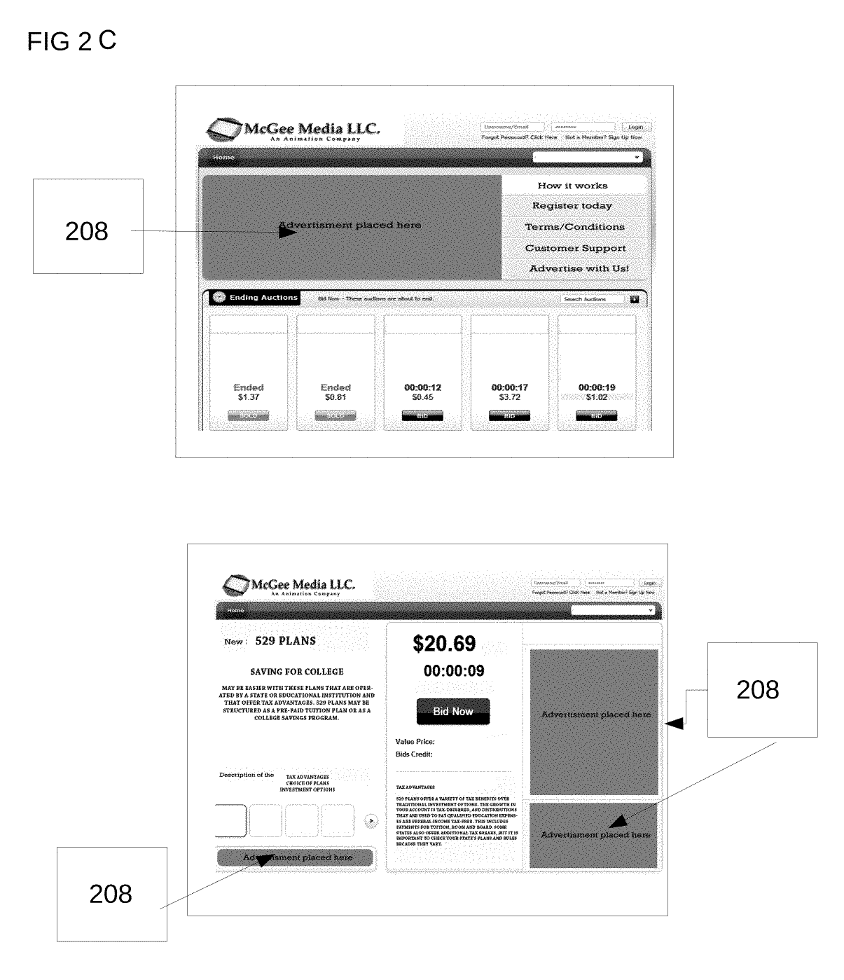

FIGS. 2A-2C illustrate the general methodology of the marketing concept behind the loyalty program and tracking system of the present invention. FIGS. 2A, 2B, and 2C extend the same concept. The company can embed a motion graphic or icon that appears in the corners of the frames with a scrolling bar and voice over during the telecast of commercials and content of media programming (step 201). Alternately, or in addition to, a short 7 second to 15 second commercial directing the viewer to the splash page to select the contest button for more information can also be embedded (step 201). These messages can inform the viewers where to register, how to play along, etc. and after receiving a confirmation email after registering, the viewers with be emailed question links that can lead them back to the company's mobile application or web portal where they need to enter a code to unlock the question and answer trivial section, as well to other games and puzzles to play along (step 202). These codes can only be found on the DVD under the chapter points section. Entering the code can unlock the question and answer trivial section, as well to other games and puzzles to play in a short time period during the video telecast and throughout the week (step 203). Viewers can be emailed through the week additional question and answer, trivial section, as well to other games and puzzles to play they can have to go back and frequently look up chapter point section for the code to unlock the games of movie (step 204). With every right answer the viewer can obtain the “marker” (token, point and or penny) that is stored in a digital vault associated with their profile on their registered page (step 205). The markers (token, point and or penny) can be used at the company auction site and the end of the week (step 206). The use of the markers is the final engagement that takes place when viewers use them for transactions on an auction site (step 207). With these markers (token, point and or penny) the produces and services that were being advertised during the telecast are now for “purchase” allowing the system to track the overall experience. Throughout the web portal or application users are playing along on the platform which can display advertising in a number of forms; from graphic, animated, words, links, video, voice over (step 208).

FIGS. 3A, 3B, and 3C illustrate the general methodology of the Anti-Hopper. After the media properties have been edited into the final pieces they are important into the system, for example Abode Encore software (step 301). Here each media piece is placed into each of their own separate timelines (step 302). Now the menu is created with all the graphics and buttons are set in place (step 303). The links for all the media properties to the menu and its buttons are set (step 304). The remote control settings are set for content (programming) media property in each time line to function like a DVR (step 305). With all the functionality from play, pause, stop, fast-forwards, rewired, chapter point, etc. The commercial section is where the anti-hopper is implemented by setting the remote control setting for (advertisement) media property in each of its time line to have the function be disabled preventing the ability to skip the advertisement (step 306). In some case a head and/or tail with graphic taglines can be inserted with “we can be right back” to “Now back to the show” with the setting of the remote control setting for each of the (these graphics) media property in each of their time line to have their function be disabled preventing the ability to skip them as well (step 307).

FIG. 4 illustrates general methodology of the marketing concept associated with the foregoing. From FIG. 4, step 401 is obtaining the media properties (programming) in exchange for a fee. Then obtaining the advertisement (commercials) in exchange for a fee (step 402). Both steps (401), (402) depend on the resources available in the market assemble the compact disc as outline above and create the finish product (step 403). The compact disc (DVD) can then be delivered to the end user, in certain examples, for free (step 404). Another example can be, for a fee, the compact disc (DVD) is sent to the end user but that fee can be waived with the purchase of a produce or services (step 405).

Note that the application and process described above can use any computing device, including a computer, laptop, smartphone, tablet, server, cloud server, etc. that have at least a processor and the ability to create files for compact discs, including DVDs. The system can also include the ability to master and then replicate the DVD for either personal use or in mass quantities. The system can include one or more non-transient memories for storing some or all of the data described above. This includes the content, advertising, user information, the menus and anti-hopping technology, the marker, the products related to the advertising, the advertiser's website, and the market exchange website. Included in the above is the ability to create and store unique user accounts that certain information can be stored in, including account information, and content selection. The computing device can also have a wired or wireless network connection to send and receive any or all of the data discussed above. In one implementation, the application includes software that is stored on a memory of the computing device and executed by the processor.

The descriptions contained herein are examples of embodiments of the invention and are not intended in any way to limit the scope of the invention. As described herein, the invention contemplates many variations and modifications of the inventive loyalty and anti-hopper systems. These modifications would be apparent to those having ordinary skill in the art to which this invention relates and are intended to be within the scope of the claims which follow.

What is claimed is:

1. A computer software preventing the skipping of digital media content on physical media, comprising the steps of:
providing to an advertiser an anti-skip technology during the digital media editing and assembly process by manipulation of the digital code to disable the remote control functionality normally used to skip or time shift, within the advertisement portion or prior to so-called chapter points, of the digital media content;
tracking a user of the physical media and transmitting to the advertiser demographic and sociological data of the use; and
providing a loyalty program allowing users of the physical media to interact with the advertiser, partially separate from the physical media and allowing the user to bid on a product sold by the advertiser.

2. The computer software of claim 1, wherein the providing the loyalty program step further comprises interacting using surveys, questions and answer sessions, puzzles, and games.

3. The computer software of claim 1, wherein the digital media content comprises an anti-skip technology.

4. The computer software of claim 1, wherein the content comprises a web-based advertising tracking system.

5. The computer software of claim 1, wherein the content comprises a web-based loyalty program.
